(19) United States
(12) Patent Application Publication
(10) Pub. No.: US 2008/0156359 A1
(43) Pub. Date: Jul. 3, 2008

(54) SYSTEMS AND METHODS FOR MODULAR AND CONFIGURABLE SUBSTRATE CLEANING

(76) Inventors: DONALD J.K. OLGADO, Palo Alto, CA (US); Ho Seon Shin, Cupertino, CA (US); Sheshraj L. Tulshibagwale, Santa Clara, CA (US); Roy C. Nangoy, Santa Clara, CA (US); Hui Chen, Burlingame, CA (US); Allen L. D'Ambra, Burlingame, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/963,458

(22) Filed: Dec. 21, 2007

Related U.S. Application Data
(60) Provisional application No. 60/882,066, filed on Dec. 27, 2006.

(51) Int. Cl. B08B 3/00

(52) U.S. Cl. 134/137

(57) ABSTRACT

Embodiments of the invention generally relate to a modular, configurable system in which distinct cleaning and drying modules can be arranged in different combinations selectable by a user of the system. In one embodiment a configurable system for substrate cleaning is provided. The configurable system provides a frame including first and second bays, the first and second bays each adapted to hold one or more cleaning or drying modules, and a transfer area positioned between the first and second bays including a robot adapted to move substrates to and from the one or more modules positioned within the first and second bays, wherein the frame is adapted to hold a user selectable set of one or more cleaning or drying modules in the first and second bays.

### CROSS-REFERENCE TO RELATED APPLICATIONS

This application claims benefit of U.S. provisional patent application Ser. No. 60/882,066, filed Dec. 27, 2006, which is herein incorporated by reference.

### BACKGROUND OF THE INVENTION

1. Field of the Invention

Embodiments of the invention generally relate to a modular, configurable system in which distinct cleaning and drying modules can be arranged in different combinations selectable by a user of the system.

2. Description of the Related Art

The process of forming electronic devices is commonly done in a multi-chamber processing system (e.g., a cluster tool) that has the capability to sequentially process substrates, (e.g., semiconductor wafers) in a controlled processing environment. Typical cluster tools used to perform semiconductor cleaning processes, commonly described as a wet/clean tool, will include a mainframe that houses at least one substrate transfer robot which transports substrates between a pod/cassette mounting device and multiple processing chambers that are connected to the mainframe. Cluster tools are often used so that substrates can be processed in a repeatable way in a controlled processing environment. A controlled processing environment has many benefits which include minimizing contamination of the substrate surfaces during transfer and during completion of the various substrate processing steps. Processing in a controlled environment thus reduces the number of generated defects and improves device yield.

The effectiveness of a substrate fabrication process is often measured by two related and important factors, which are device yield and the cost of ownership (CoO). These factors are important since they directly affect the cost to produce an electronic device and thus a device manufacturer's competitiveness in the market place. The CoO, while affected by a number of factors, is greatly affected by the system and chamber throughput, or simply the number of substrates per hour processed using a desired processing sequence. A process sequence is generally defined as the sequence of device fabrication steps, or process recipe steps, completed in one or more processing chambers in the cluster tool. A process sequence may generally contain various substrate (or wafer) electronic device fabrication processing steps. In an effort to reduce CoO, electronic device manufacturers often spend a large amount of time trying to optimize the process sequence and chamber processing time to achieve the greatest substrate throughput possible given the cluster tool architecture limitations and the chamber processing times.

Other important factors in the CoO calculation are the system reliability and system uptime. These factors are very important to a cluster tool's profitability and/or usefulness, since the longer the system is unable to process substrates the more money is lost by the user due to the lost opportunity to process substrates in the cluster tool. Therefore, cluster tool users and manufacturers spend a large amount of time trying to develop reliable processes, reliable hardware, reliable transferring methods and reliable systems that have increased uptime.

Extraordinarily high levels of cleanliness are generally required during the fabrication of semiconductor substrates. During the fabrication of semiconductor substrates, multiple cleaning steps are typically required to remove impurities from the surfaces of the substrates before subsequent processing. The cleaning of a substrate, known as surface preparation, has for years been performed by exposing multiple substrates to a sequence of chemical and rinse steps and eventually to a final drying step. A typical surface preparation procedure may include etch, clean, rinse and dry steps. During a typical cleaning step, the substrates are exposed to a cleaning solution that may include water, ammonia or hydrochloric acid, and hydrogen peroxide. After cleaning, the substrates are rinsed using ultra-pure water and then dried using one of several known drying processes.

Therefore, there is a need for a system, a method and an apparatus that can meet the required device performance goals, has a high substrate throughput, and thus reduces the process sequence CoO.

### SUMMARY OF THE INVENTION

Embodiments of the invention generally relate to a modular, configurable system in which distinct cleaning and drying modules can be arranged in different combinations selectable by a user of the system. In one embodiment a configurable system for substrate cleaning is provided. The configurable system provides a frame including first and second bays, the first and second bays each adapted to hold one or more cleaning or drying modules, and a transfer area positioned between the first and second bays including a robot adapted to move substrates to and from the one or more modules positioned within the first and second bays, wherein the frame is adapted to hold a user selectable set of one or more cleaning or drying modules in the first and second bays.

In another embodiment a configurable system for substrate cleaning is provided. The configurable system provides a first frame including first and second bays, the first and second bays each adapted to hold one or more cleaning or drying modules, a transfer area positioned between the first and second bays of the first frame including a robot adapted to move substrates to and from the one or more modules positioned within the first and second bays, a second frame including first and second bays adapted to hold one or more cleaning or drying modules, wherein the first frame and the second frame are adapted to hold a user selectable set of one or more cleaning or drying modules in their respective first and second bays.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of an exemplary embodiment of a first configurable system for cleaning and/or drying a substrate provided in accordance with the present invention;

FIG. 2 is a top plan view showing an exemplary embodiment of a second configurable system for cleaning and/or drying a substrate provided in accordance with the present invention;

FIG. 3 is a top plan view showing an alternative configuration of the multi-frame system shown in FIG. 2; and

FIG. 4 is a top plan view showing an alternative configuration of the multi-frame system shown in FIG. 2.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Semiconductor device processing often includes polishing and subsequent cleaning procedures in which the surface of a substrate may be polished with an abrasive material, cleaned to remove dislodged particles and the abrasive polishing material and then rinsed and dried. There are a number of different cleaning methods and mechanisms that may be used individually or in combination in a given cleaning process. For example, a cleaning sequence may include Megasonic vibration, brush-scrubbing and/or bevel cleaning, in addition to further rinsing and drying procedures. The type and number of procedures employed may vary depending on the semiconductor device processing application. In addition, it may be useful to select and vary the orientation of a substrate during one or more cleaning procedures to increase efficiency or throughput.

The present invention provides a modular, configurable system in which distinct cleaning and drying modules can be arranged in different combinations selectable by a user of the system. The system includes a frame having bays in which one or more modules can be removably attached. A transfer area having a robot transfers substrates to and from the various modules within the bays.

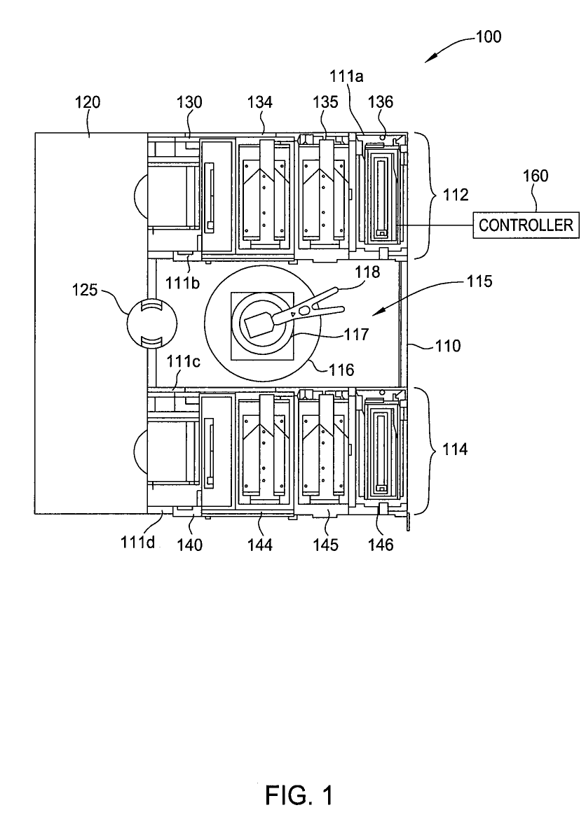

FIG. 1 is a top plan view of an exemplary embodiment of a first configurable system 100 for cleaning and/or drying a substrate provided in accordance with the present invention. The first system 100 includes a frame 110 having cross-beams 111a-d that define three regions: a first bay 112 positioned toward a first side of the frame 110, a second bay 114 positioned toward a second (opposite) side of the frame 110, and a transfer area 115 positioned between the first and second bays 112, 114. The frame 110 is coupled to a factory interface 120 and may receive substrates from or transfer substrates to the factory interface 120 through a port 125. In some embodiments, the frame 110 may be removably attached to the factory interface 120 via one or more screws, bolts or other fasteners (not shown).

The first and second bays 112, 114 include areas in which one or more cleaning and/or drying modules may be affixed or suspended. In the exemplary embodiment shown in FIG. 1, the first bay 112 includes a vapor drying module 130, and three vertical modules 134, 135, 136. In some embodiments, the vapor drying module 130 and vertical modules 134, 135, 136 may be coupled to the portions of the frame 110 that define the edges of the first bay 112 (e.g., cross beams 111a-b) and may be viewed as extending out of or into the page.

The vapor drying module 130 may comprise any drying module that effectively dries substrates such as a low pressure dryer or a Marangoni dryer. The vertical modules 134, 135, 136 may each comprise a cleaning, rinsing or additional drying module, such as a Megasonic cleaner, a brush scrubber, a spin-rinse dryer, and/or a Marangoni dryer, or combinations thereof. A ‘vertical’ module is one in which a substrate is processed while in a substantially vertical orientation. Vertical modules may be advantageous in some applications because vertical modules occupy a smaller footprint than modules that process substrates in a substantially horizontal orientation (“horizontal modules”). Vertical modules thus save space, and certain processes, such as Marangoni drying, may be more effective when a substrate is oriented vertically. Exemplary modules and/or systems are described in commonly assigned U.S. Provisional Patent Application Ser. No. 60/882,894, filed Dec. 29, 2006, entitled MULTIPLE SUBSTRATE VAPOR DRYING SYSTEMS AND METHODS, and U.S. Provisional Patent Application Ser. No. 60/871,914, filed Dec. 26, 2006, entitled HORIZONTAL MEGASONIC MODULE FOR CLEANING SUBSTRATES, which are both hereby incorporated in their entirety.

Each of the modules 130, 134, 135, 136 has an opening or port (not shown) for receiving or transferring a substrate. The opening or port of the modules may comprise a slit slightly larger than a substrate that can be sealed when not in use to prevent fluids or gases from entering or emerging from the module into the transfer area 115. Other opening types may be used. It is noted in this regard that multiple substrates may be processed simultaneously within a bay. For example, a substrate may be cleaned in module 136 while another substrate is being cleaned or rinsed in module 135. In some embodiments, substrates are simultaneously and/or independently processed in each module.

In the embodiment depicted, the second bay 114 also includes a vapor drying module 140 and three vertical modules 144, 145, 146. These modules may be the same as or different from the modules used in the first bay 112.

In one or more embodiments, any of the modules in the first and second bays 112, 114 may be disengaged and/or removed from the bays whenever it is so desired. The modules can be removed and replaced with similar or different module types. In this manner, a user may customize the system 100 to include specific cleaning, rinsing and/or drying modules suited for any given application. The user may also remove one or more modules for maintenance whenever necessary and simply replace any removed module with a similar module to continue operation of the system 100 as a whole while the removed module is being repaired.

The transfer area 115, positioned between the first and second bays 112, 114, includes a platform 116 on which a robot 117 may be supported. The robot 117 includes a substrate holder (end effector) 118 which may contact and securely hold a substrate (e.g., by applying a suction force via a vacuum chuck, by using an edge gripper or by using some other controllable attachment mechanism). In some embodiments, the robot 117 may rotate the substrate holder 118 in the plane of the page and in a plane perpendicular to the page. The robot 117 is movable so as to deliver a substrate to (or receive a substrate from) any module positioned within the first and second bays 112, 114. It is noted that if the substrate holder 118 is rotatable in a plane perpendicular to the page, a substrate may be delivered to one of the vertical modules in a vertical orientation.

In some embodiments, a controller 160 may detect the presence of the modules within the first and second bays 112, 114. For example, the controller 160 may determine various positions and/or dimensions of the modules. This information may allow the controller 160 to calibrate the robot 117 and/or direct the robot 117 to precise locations relative to the openings of the modules so that the robot 117 may receive substrates through the openings or transfer substrates into the openings of the modules in any configuration. Additionally or alternatively, the controller 160 may control processing within one or more of the modules.

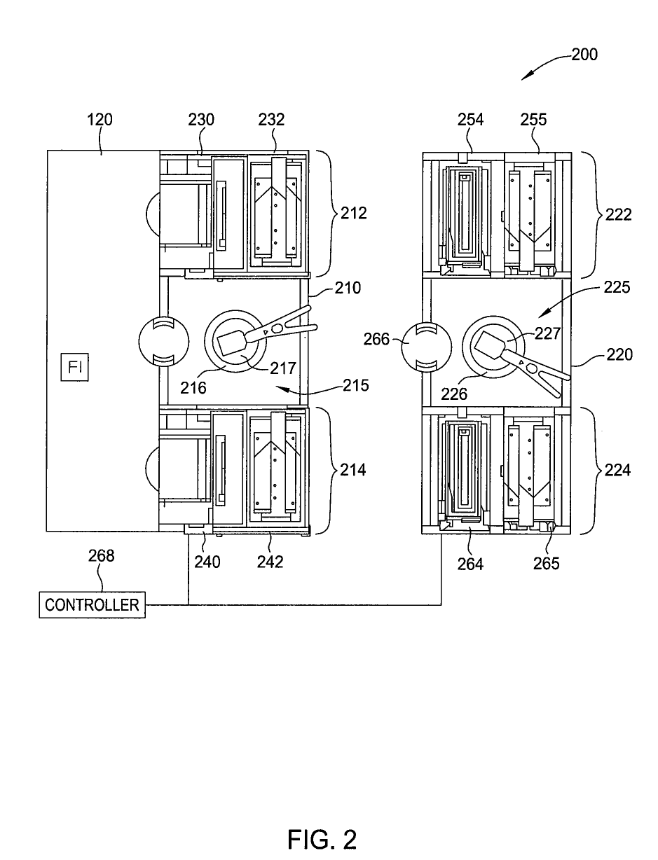

FIG. 2 is a top plan view showing an exemplary embodiment of a second configurable system 200 for cleaning and/or drying a substrate provided in accordance with the present invention. In this embodiment, the system 200 includes two separate frames 210, 220. It is noted that more than two frames may also be used. While the frames 210, 220 are shown as being separate, in some embodiments the frames 210, 220 may be directly attached/coupled together, or coupled via an enclosure such as a tunnel, a tunnel frame, or a similar structure. One of the frames 210 (the ‘first frame’) is coupled to the factory interface 120. First frame 210 includes first bay 212 and second bay 214 and transfer area 215. Likewise, second frame 220 includes first and second bays 222, 224 and transfer area 225. Each of the transfer areas of the two frames 210, 220 includes respective platforms 216, 226 and robots 217, 227.

In some embodiments, the multi-frame configuration of the system 200 allows the bays of one of the frames 210, 220 to house and/or support ‘m’ number of vertical modules and the bays of the other frame to house and/or support ‘n’ number of horizontal modules. In other embodiments, each frame 210, 220 may house and/or support a combination of vertical and horizontal modules. Alternately, each frame 210, 220 may house and/or support only vertical or horizontal modules. The frames 210, 220 may be used together in a processing system whenever deemed suitable.

In the example embodiment depicted in FIG. 2, the first bay 212 of the first frame 210 includes a vapor dryer 230 and one vertical module 232, and the second bay 214 of the first frame 210 also includes a vapor dryer 240 and a vertical module 242. The first bay 222 of the second frame 220 has an area adapted to hold either two vertical modules 254, 255 (as shown) or one horizontal module (not shown) since a horizontal module encompasses more of the area of the bay (in the horizontal plane). While vertical modules have a smaller footprint, there are applications in which horizontal modules may be advantageous, such as when cleaning and/or rinsing hydrophobic substrates because fluids tend to be better distributed over a hydrophobic substrate when the substrate is oriented horizontally. Accordingly, using the first bay 222, a user has the option of including a horizontal cleaning/rinsing module in a larger cleaning/rinsing/drying system. Similarly, the second bay 224 may include two vertical modules 264, 265 (as shown) or one horizontal module (not shown). First and second bays 222, 224 may be dimensioned to hold a smaller or greater number of vertical and/or horizontal modules.

One of the advantages of using two or more frames is that it allows several modules that are suitable for a given application to be arranged together. For example, horizontal modules may be employed with a first frame independently from vertical modules employed with a second frame whenever required, and/or a user or manufacturer may selectively employ modules to accommodate either horizontal or vertical substrate processing. Further, robot designs may be simplified and/or robot axes of motion reduced if a robot need only exchange substrates with vertical or horizontal modules (but not both).

A transfer location may be provided for transferring substrates between the modules of the first frame 210 and the second frame 220. For example, in the embodiment of FIG. 2, a transfer location 266 is provided on the second frame 220 that may be used to transfer substrates between the robot 217 of the first frame 210 and the robot 227 of the second frame 220. For example, a substrate may be placed on the transfer location 266 by the robot 217, retrieved from the transfer location 266 by the robot 227, processed in the modules 254, 255, 264 and/or 265, placed on the transfer location 266 by the robot 227, and retrieved from the transfer location 266 by the robot 227 (e.g., for further processing by the modules 230, 232, 240 and/or 242, for transfer to the factory interface 120, or the like). The transfer location 266 may be located at any other suitable location such as on the first frame 210. A controller 268 may be employed to detect the presence of modules in the system 200 and/or to control operation of the robots and/or modules of the system 200.

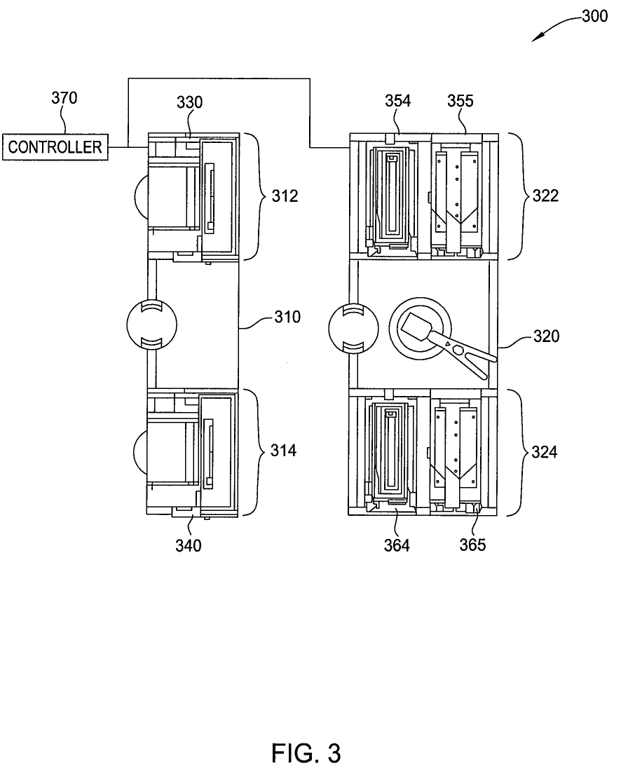

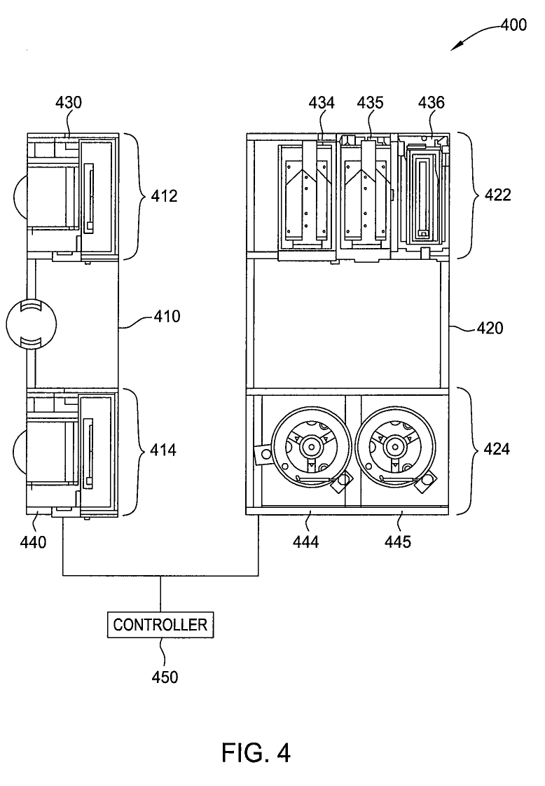

FIGS. 3 and 4 are top plan views showing alternative configurations of a multi-frame system respectively as shown in FIG. 2. In the cleaning and/or drying configuration of system 300 of FIG. 3, a first frame 310 includes first and second bays 312, 314 that are narrower than the bays of the embodiment shown in FIG. 2. In this case, the first and second bays 312, 314 each include a vapor drying module 330, 340 but do not include any other modules. The second frame 320 includes a first bay 322 dimensioned so as to hold two vertical modules 354, 355 (as shown) or one horizontal module (not shown). Similarly, the second bay 324 is dimensioned so as to hold two vertical modules 364, 365 (as shown) or one horizontal module (not shown). A controller 370 may be employed to detect the presence of modules in the system 300 and/or to control operation of robots and/or modules in the system 300.

In the cleaning and/or drying configuration of system 400 of FIG. 4, a first frame 410 includes first and second bays 412, 414 that are narrower than the bays of the embodiment of FIG. 2. In this case, the first and second bays 412, 414 each include a vapor drying module 430, 440 but do not include any other modules. The second frame 420 includes first and second bays 422, 424 that are wider than those shown in the embodiments of FIGS. 2 and 3. As shown, the first bay 422 is wide enough to hold three vertical modules 434, 435 and 436, while the second bay 424 holds two horizontal modules 444, 445. A controller 450 may be employed to detect the presence of modules in the system 400 and/or to control operation of robots (not shown) and/or modules in the system 400.

While the frames of the systems 300-400 are shown as being separate, in some embodiments the frames may be directly attached/coupled together, or coupled via an enclosure such as a tunnel, a tunnel frame or a similar structure.

It is again noted that the systems depicted in FIGS. 2-4 are exemplary and that, in general, the frames may be dimensioned so as to hold ‘m’ number of vertical modules and ‘n’ number of horizontal modules and may be configured depending on customer need and/or application of various cleaning, rinsing and/or drying techniques. By using a frame that may incorporate both vertical and horizontal modules, high throughput can be achieved in part because substrates may be moved easily between vertical and horizontal modules by a robot positioned within a transfer area, avoiding external transfers with the factory interface. Moreover, multiple substrates can be processed simultaneously.

In one or more embodiments, any of the modules in the systems 100-400 described herein may be disengaged and/or removed whenever it is so desired. The modules can be removed and replaced with similar or different module types. In this manner, a user may customize each system 100-400 to include specific cleaning, rinsing and/or drying modules suited for any given application. The user may also remove one or more modules for maintenance whenever necessary and simply replace any removed module with a similar module to continue operation of the system as a whole while the removed module is being repaired.

The foregoing description discloses only exemplary embodiments of the invention. Modifications of the above disclosed apparatus and methods which fall within the scope of the invention will be readily apparent to those of ordinary skill in the art. For instance, each system 100, 200, 300 and/or 400 may include a controller for controlling processing, transfer and/or any other operation for a substrate. Each controller may include software, hardware or a combination of the same.

Accordingly, while the present invention has been disclosed in connection with specific embodiments thereof, it should be understood that other embodiments may fall within the spirit and scope of the invention, as defined by the following claims.

1. A configurable system for substrate cleaning comprising:
a frame including first and second bays, the first and second bays each adapted to hold one or more cleaning or drying modules; and
a transfer area positioned between the first and second bays including a robot adapted to move substrates to and from the one or more modules positioned within the first and second bays;
wherein the frame is adapted to hold a user selectable set of one or more cleaning or drying modules in the first and second bays.

2. The system of claim 1, wherein the frame has four cross-beams defining the first bay, the second bay, and the transfer area.

3. The system of claim 1, further comprising a factory interface coupled to the frame, wherein the frame may receive substrates from or transfer substrates to the factory interface through a port.

4. The system of claim 3, wherein the frame is removably attached to the factory interface.

5. The system of claim 1, wherein the one or more modules of the first bay comprises a vapor drying module and three vertical modules each adapted to process a substrate in a substantially vertical orientation.

6. The system of claim 5, wherein the vapor drying module and the vertical modules are coupled to portions of the frame that define the edges of the first bay.

7. The system of claim 5, wherein the vertical modules each comprise a cleaning, rinsing, or drying module.

8. The system of claim 5, wherein the one or more modules of the second bay comprises a vapor drying module and three vertical modules each adapted to process a substrate in a substantially vertical orientation.

9. The system of claim 8, wherein the one or more modules of the first and second bay may be disengaged and/or removed from the first and second bay.

10. A configurable system for substrate cleaning comprising:
a first frame including first and second bays, the first and second bays each adapted to hold one or more cleaning or drying modules;
a transfer area positioned between the first and second bays of the first frame including a robot adapted to move substrates to and from the one or more modules positioned within the first and second bays;
a second frame including first and second bays adapted to hold one or more cleaning or drying modules; and
a transfer area positioned between the first and second bays of the second frame including a robot adapted to move substrates to and from the one or more modules in their respective first and second bays;
wherein the first frame and the second frame are adapted to hold a user selectable set of one or more cleaning or drying modules in their respective first and second bays.

11. The system of claim 10, wherein the one or more modules of the first and second bay may be disengaged and/or removed from the first and second bay.

12. The system of claim 10, wherein the first bay and the second bay of the first frame each includes a vapor dryer and a vertical module.

13. The system of claim 12, wherein the first bay of the second frame has an area adapted to hold two vertical modules.

14. The system of claim 13, wherein the second bay of the second frame has an area adapted to hold two vertical modules.

15. The system of claim 10, wherein the first frame contains one module.

16. The system of claim 15, wherein the one or more modules of the second frame are vertical modules.

17. The system of claim 11, wherein either the first frame or the second frame further comprises a transfer location that may be used to transfer substrates between the robot of the first frame and the robot of the second frame.

18. The system of claim 10, wherein the first and second bays of the first frame each include a vapor drying module but do not include any other any other modules.

19. The system of claim 18, wherein the first bay and the second bay of the second frame are dimensioned to hold two vertical modules.

20. The system of claim 18, wherein the first bay of the second frame is dimensioned to hold three vertical modules and the second bay of the second frame is dimensioned to hold two horizontal modules.
